(19) United States
(12) Patent Application Publication
(10) Pub. No.: US 2023/0209320 A1
(43) Pub. Date: Jun. 29, 2023

(54) SYSTEMS AND METHODS FOR COMMUNICATING WITH A FIRST RESPONDER DISPATCHER

(71) Applicant: B7 Solutions Inc., Brooklyn, NY (US)

(72) Inventor: Mayer Tabak, Brooklyn, NY (US)

(21) Appl. No.: 17/926,270

(22) PCT Filed: May 19, 2021
(86) PCT No.: PCT/US2021/033098

§ 371 Date: Nov. 18, 2022

Related U.S. Application Data
(60) Provisional application No. 63/026,982, filed on May 19, 2020.

(51) Int. Cl. H04W 4/90; H04M 3/51; H04W 4/021

(52) U.S. Cl. CPC H04W 4/90; H04M 3/5116; H04W 4/021

(57) ABSTRACT

Systems and methods for communications with a first responder dispatcher are disclosed. In aspects, a system for includes a database, processor(s), and memory storing instructions. The database includes public safety answering points (PSAPs), geographic coverage information for the PSAPs, and enrollment information for the PSAPs. The instructions, when executed by the processor(s), cause the system to: receive a request for a PSAP from a smart mobile device where the request includes information indicating a location of the smart mobile device; determine a target PSAP based on comparing the location of the smart mobile device with geographic coverage information for the PSAPs; in case the target PSAP is enrolled, connect the smart mobile device with the target PSAP using a connection separate from an emergency services voice connection; and in case the target PSAP is not enrolled, instruct the smart mobile device to initiate an emergency services voice connection.

### CROSS REFERENCE TO RELATED APPLICATIONS

The present application claims the benefit of and priority to U.S. Provisional Application No. 63/026,982, filed on May 19, 2020, which is hereby incorporated by reference herein in its entirety.

### TECHNICAL FIELD

The present disclosure relates to communicating with a first responder dispatcher, and more particularly, to communicating information with a first responder dispatcher using a smart mobile device.

### BACKGROUND

Emergency services first responders include police, firemen, and emergency medical personnel. First responders rely on information from dispatchers to have sufficient information for responding to an emergency. Dispatchers typically receive information by a telephone voice call during which a caller explains the nature of the emergency to the dispatcher. Voice calls serve an important role in having trained dispatchers vocally and emotionally assure the caller that help is on the way. Accordingly, voice calls to dispatchers should not be eliminated. While voice calls are helpful, it may take too long for a dispatcher to elicit enough information from a caller to understand the extent of the emergency. There is interest in developing systems and methods for communicating more information with a first responder dispatcher.

### SUMMARY

The present disclosure relates to systems and methods for communicating information with a first responder dispatcher using a smart mobile device.

In accordance with aspects of the present disclosure, a system is disclosed for connecting smart mobile devices of users requesting first responders with first responder dispatcher devices. The system includes: a database of public safety answering points, geographic coverage information for the public safety answering points, and enrollment information for the public safety answering points; one or more processors; and at least one memory storing instructions. The instructions, when executed by the one or more processors, cause the system to: receive a request for emergency services from a smart mobile device where the request includes information indicating a location of the smart mobile device; determine a target public safety answering point based on comparing the location of the smart mobile device with the geographic coverage information for the public safety answering points; in case the enrollment information indicates that the target public safety answering point is enrolled, connect the smart mobile device with the target public safety answering point, where the connection is separate from an emergency services voice connection; and in case the enrollment information indicates that the target public safety answering point is not enrolled, instruct the smart mobile device to initiate an emergency services voice connection.

In various embodiments of the system, the system includes customized display content for the target public safety answering point, and the instructions, when executed by the one or more processors, further cause the system to: communicate the customized display content for the target public safety answering point to the smart mobile device; receive, from the smart mobile device, user selections based on the customized display content; and communicate the user selections to the target public safety answering point.

In various embodiments of the system, the instructions, when executed by the one or more processors, further cause the system to: receive, from the smart mobile device, user selections based on default display content; and communicate the user selections to the target public safety answering point.

In accordance with aspects of the present disclosure, a method is disclosed for connecting smart mobile devices of users requesting first responders with first responder dispatcher devices. The method includes: receiving a request for emergency services from a smart mobile device, where the request includes information indicating a location of the smart mobile device; accessing a database of public safety answering points, geographic coverage information for the public safety answering points, and enrollment information for the public safety answering points; determining a target public safety answering point based on comparing the location of the smart mobile device with the geographic coverage information for the public safety answering points; in case the enrollment information indicates that the target public safety answering point is enrolled, connecting the smart mobile device with the target public safety answering point, where the connection is separate from an emergency services voice connection; and in case the enrollment information indicates that the target public safety answering point is not enrolled, instructing the smart mobile device to initiate an emergency services voice connection.

In various embodiments of the method, the method includes: communicating customized display content for the target public safety answering point to the smart mobile device; receiving, from the smart mobile device, user selections based on the customized display content; and communicating the user selections to the target public safety answering point.

In various embodiments of the method, the method includes: receiving, from the smart mobile device, user selections based on default display content; and communicating the user selections to the target public safety answering point.

In accordance with aspects of the present disclosure, a machine-readable medium stores instructions which implement an operation for connecting smart mobile devices of users requesting first responders with first responder dispatcher devices. The instructions, when executed by one or more processors, cause performance of the operation, which includes: receiving a request for emergency services from a smart mobile device, where the request includes information indicating a location of the smart mobile device; accessing a database of public safety answering points, geographic coverage information for the public safety answering points, and enrollment information for the public safety answering points; determining a target public safety answering point based on comparing the location of the smart mobile device with the geographic coverage information for the public safety answering points; in case the enrollment information indicates that the target public safety answering point is enrolled, connecting the smart mobile device with the target public safety answering point, where the connection is separate from an emergency services voice connection; and in case the enrollment information indicates that the target public safety answering point is not enrolled, instructing the smart mobile device to initiate an emergency services voice connection.

In accordance with aspects of the present disclosure, a dispatcher system is disclosed for connecting with smart mobile devices of users requesting first responders. The dispatcher system includes a display screen, one or more processors, and at least one memory storing instructions. The instructions, when executed by the one or more processors, cause the dispatcher system to: display, on the display screen, a plurality of messaging applications for communicating messages with a plurality of smart mobile device of users requesting first responders; display, on the display screen, a plurality of call buttons corresponding to the plurality of smart mobile devices and configured to connect voice calls with the plurality of smart mobile devices; and in response to receiving a selection of one call button among the plurality of call buttons: connect a voice call with the smart mobile device corresponding to the one call button, transfer sessions corresponding to other call buttons among the plurality of call buttons to one or more available dispatchers, and close the messaging applications corresponding to the transferred sessions on the display screen.

In accordance with aspects of the present disclosure, a method in a dispatcher system is disclosed for connecting with smart mobile devices of users requesting first responders, where the dispatcher system includes a display screen. The method includes: displaying, on the display screen, a plurality of messaging applications for communicating messages with a plurality of smart mobile device of users requesting first responders; displaying, on the display screen, a plurality of call buttons corresponding to the plurality of smart mobile devices and configured to connect voice calls with the plurality of smart mobile devices; and in response to receiving a selection of one call button among the plurality of call buttons: connecting a voice call with the smart mobile device corresponding to the one call button, transferring sessions corresponding to other call buttons among the plurality of call buttons to one or more available dispatchers, and closing the messaging applications corresponding to the transferred sessions on the display screen.

In accordance with aspects of the present disclosure, a machine-readable medium stores instructions which implement an operation in a dispatcher system for connecting with smart mobile devices of users requesting first responders, where the dispatcher system includes a display screen. The instructions, when executed by one or more processors, cause performance of the operation, which includes: displaying, on the display screen, a plurality of messaging applications for communicating messages with a plurality of smart mobile device of users requesting first responders; displaying, on the display screen, a plurality of call buttons corresponding to the plurality of smart mobile devices and configured to connect voice calls with the plurality of smart mobile devices; and in response to receiving a selection of one call button among the plurality of call buttons: connecting a voice call with the smart mobile device corresponding to the one call button, transferring sessions corresponding to other call buttons among the plurality of call buttons to one or more available dispatchers, and closing the messaging applications corresponding to the transferred sessions on the display screen.

In accordance with aspects of the present disclosure, a mobile device is disclosed for communicating with a dispatcher device of a first responder dispatcher. The mobile device includes a display screen, a GPS receiver, a processor, and a memory storing instructions. The instructions, when executed by the processor, cause the mobile device to: communicate a request for a public safety answering point to a server having a database of public safety answering points, geographic coverage information for the public safety answering points, and enrollment information for the public safety answering points, where the request includes location information provided by the GPS receiver; in case of receiving a response from the server that a target public safety answering point, determined by the server based on comparing the location information with the geographic coverage information for the public safety answering points, is enrolled based on the enrollment information: connect with the target public safety answering point where the connection is separate from an emergency services voice connection, and display information selections on the display screen for communicating a request for a first responder to the target public safety answering point; and in case of receiving a response from the server that the target public safety answering point is not enrolled, initiate an emergency services voice connection.

In various embodiments of the mobile device, the information selections are customized to the target public safety answering point and are received from the server.

In various embodiments of the mobile device, the information selections are default information selections.

In various embodiments of the mobile device, in the case the target public safety answering point is enrolled, the instructions, when executed by the processor, further cause the mobile device to display, on the display screen, a call button configured to connect an emergency services voice call to the target public safety answering point.

In accordance with aspects of the present disclosure, a method in a mobile device is disclosed for communicating with a dispatcher device of a first responder dispatcher, where the mobile device includes a display screen and a GPS receiver. The method includes: communicating a request for a public safety answering point to a server having a database of public safety answering points, geographic coverage information for the public safety answering points, and enrollment information for the public safety answering points, where the request includes location information provided by the GPS receiver; in case of receiving a response from the server that a target public safety answering point, determined by the server based on comparing the location information with the geographic coverage information for the public safety answering points, is enrolled based on the enrollment information: connecting with the target public safety answering point, where the connection is separate from an emergency services voice connection, and displaying information selections on the display screen for communicating a request for a first responder to the target public safety answering point; and in case of receiving a response from the server that the target public safety answering point is not enrolled, initiating an emergency services voice connection.

In various embodiments of the method, the information selections are customized to the target public safety answering point and are received from the server.

In various embodiments of the method, the information selections are default information selections.

In various embodiments of the method, the method includes, in the case the target public safety answering point is enrolled, displaying, on the display screen, a call button configured to connect an emergency services voice call to the target public safety answering point.

In accordance with aspects of the present disclosure, a machine-readable medium stores instructions which implement an operation in a mobile device for communicating with a dispatcher device of a first responder dispatcher, where the mobile device includes a display screen and a GPS receiver. The instructions, when executed by one or more processors, cause performance of the operation, which includes: communicating a request for a public safety answering point to a server having a database of public safety answering points, geographic coverage information for the public safety answering points, and enrollment information for the public safety answering points, where the request includes location information provided by the GPS receiver; in case of receiving a response from the server that a target public safety answering point, determined by the server based on comparing the location information with the geographic coverage information for the public safety answering points, is enrolled based on the enrollment information: connecting with the target public safety answering point, where the connection is separate from an emergency services voice connection, and displaying information selections on the display screen for communicating a request for a first responder to the target public safety answering point; and in case of receiving a response from the server that the target public safety answering point is not enrolled, initiating an emergency services voice connection.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a diagram of an exemplary system for communications between a first responder dispatcher and a user, in accordance with aspects of the present disclosure;

FIG. 2 is a diagram of an exemplary display screen of a smart mobile device for initiating an emergency communication, in accordance with aspects of the present disclosure;

FIG. 3 is a diagram of an exemplary display screen of a smart mobile device for requesting an emergency first responder, in accordance with aspects of the present disclosure;

FIG. 4 is a diagram of an exemplary display screen of a smart mobile device for indicating the nature of a medical emergency, in accordance with aspects of the present disclosure;

FIG. 5 is a diagram of an exemplary display screen of a smart mobile device for indicating a physical injury, in accordance with aspects of the present disclosure;

FIG. 6 is a diagram of an exemplary display screen of a smart mobile device for indicating a cause of an injury, in accordance with aspects of the present disclosure;

FIG. 7 is a diagram of an exemplary display screen of a smart mobile device that is communicating with a first responder dispatcher, in accordance with aspects of the present disclosure;

FIG. 8 is a diagram of an exemplary display screen of a dispatcher device that is awaiting an emergency communication, in accordance with aspects of the present disclosure;

FIG. 9 is a diagram of an exemplary display screen of a dispatcher device that is communicating with one smart mobile device, in accordance with aspects of the present disclosure;

FIG. 10 is a diagram of an exemplary display screen of a dispatcher device that is communicating with four smart mobile devices, in accordance with aspects of the present disclosure;

FIG. 11 is a diagram of another exemplary display screen of a dispatcher device that is communicating with four smart mobile devices, in accordance with aspects of the present disclosure;

FIG. 12 is a diagram of an exemplary display screen of a dispatcher device that is has completed an emergency dispatch with one smart mobile device, in accordance with aspects of the present disclosure;

FIG. 13 is a flow diagram of an exemplary operation of a central server, in accordance with aspects of the present disclosure;

FIG. 14 is a flow diagram of an exemplary operation of a smart mobile device, in accordance with aspects of the present disclosure; and

FIG. 15 is a flow diagram of an exemplary operation of a dispatcher device, in accordance with aspects of the present disclosure.

### DETAILED DESCRIPTION

The present disclosure relates to systems and methods for communicating information with a first responder dispatcher using a smart mobile device. One aspect of the present disclosure provides users of smart mobile devices with a software app that enables them to provide an emergency communication to a first responder dispatcher with information regarding the emergency. One aspect of the present disclosure provides first responder dispatchers with a dispatcher device that displays emergency communications from smart mobile device users and allows the dispatcher to send questions or messages to the user.

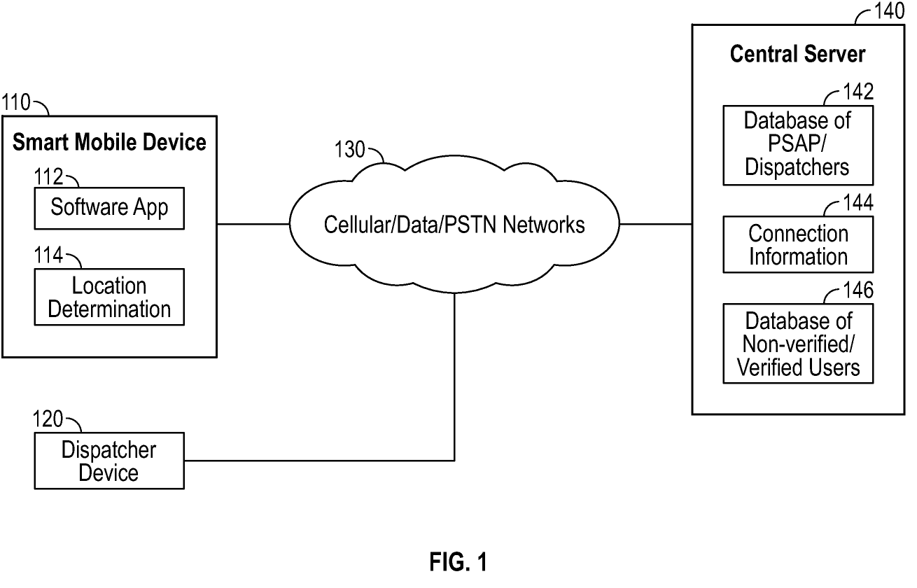

Referring to FIG. 1, there is shown a diagram of an exemplary system that enables communications between a first responder dispatcher and a user. The system involves a smart mobile device 110 belonging to a user, a first responder dispatcher device 120, a mixed network 130 that enables communications between the smart mobile device 110 and the dispatcher device 120, and a central server 140.

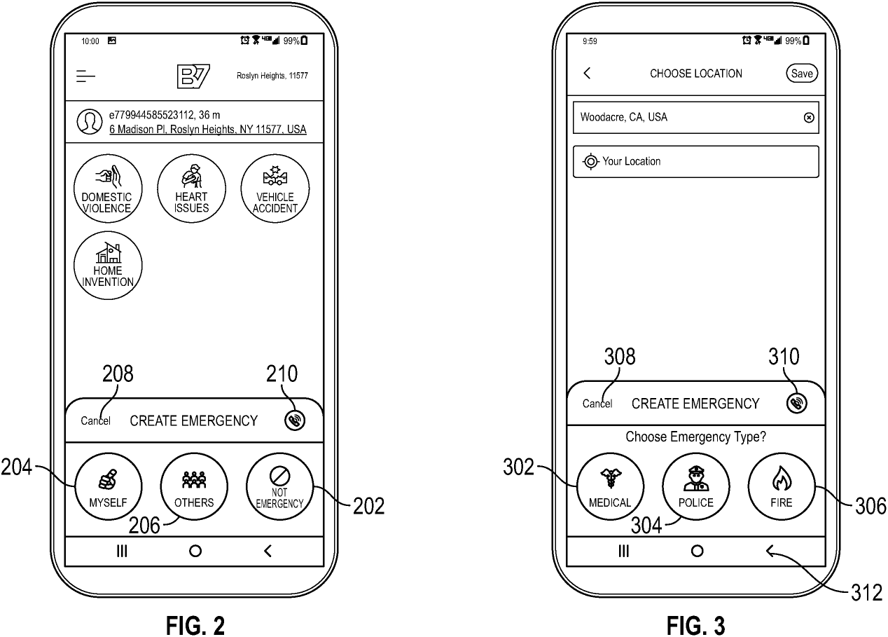

The smart mobile device 110 includes an emergency services software app 112 and a location determination capability 114, among other things. In various embodiments, the smart mobile device 110 can be a smartphone, a tablet, a laptop, a smart watch, or another type of mobile device. As persons skilled in the art will understand, a smart mobile devices includes many components, and such components are not all illustrated in FIG. 1 to provide a clearer illustration. Such other components can include, for example, a processor, memory, a display screen, an electronic storage, a networking transceiver (e.g., Wi-Fi, Ethernet), a user interface, a power source, a mobile operating system (e.g., iOS, Android), a GPS (Global Positioning System) receiver, and/or other components which persons skilled in the art will recognize. The software app 112 will be described in more detail in connection with FIGS. 2-7. For now, it is sufficient to note that the software app 112 enables display screens and communication capabilities which provide information to and receive information from a first responder dispatcher. The location determination capability 114 can use a GPS receiver or other location determination technologies, such as cellular triangulation or Wi-Fi network recognition. Such technologies will be understood by persons skilled in the art and are contemplated to be within the scope of the present disclosure.

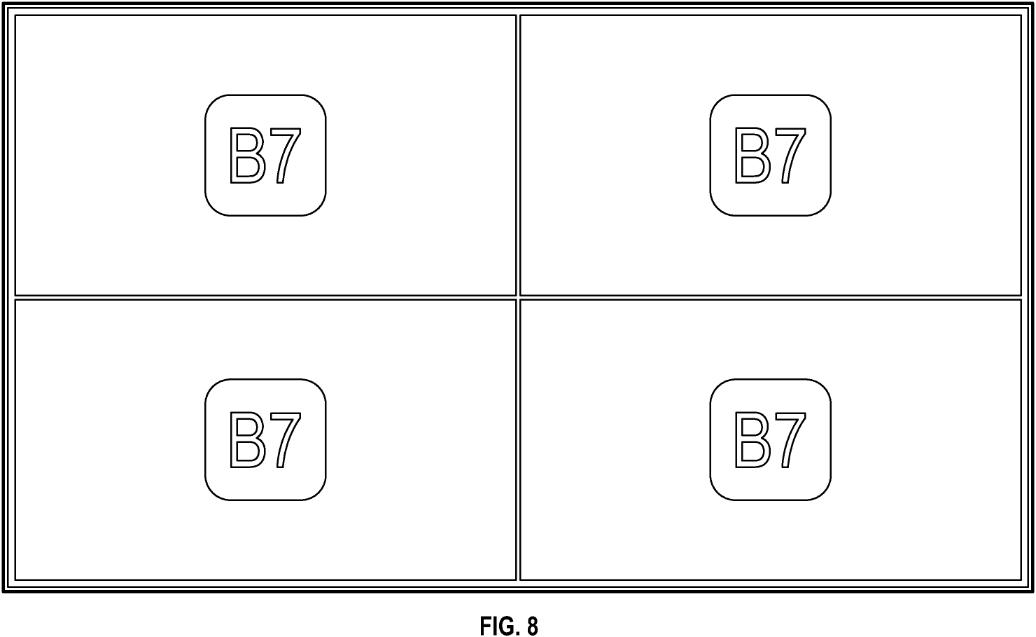

The dispatcher device 120 is located with a first responder dispatcher of a public safety answering point (PSAP), which can be any PSAP which has enrolled with the central server 140 of the disclosed system. As used herein, the term “PSAP” refers to and includes a communications point that has been designated to receive emergency services calls and route them to emergency service personnel. The dispatcher device 120 can be a desktop computer, a laptop, a tablet, or another computing device having a display screen. As persons skilled in the art will understand, a dispatcher device includes many components, and such components are not all illustrated in FIG. 1 to provide a clearer illustration. Such other components can include, for example, a processor, memory, a display screen, an electronic storage, a networking transceiver (e.g., Wi-Fi, Ethernet), a user interface, a power source, an operating system (e.g., iOS, Windows), and/or other components which persons skilled in the art will recognize. The display screens of the dispatcher device 114 will be described in more detail in connection with FIGS. 8-12. For now, it is sufficient to note that the dispatcher device 114 enables display screens and communication capabilities which provide information to and receive information from the emergency services software app 112 of a smart mobile device 110.

The mixed network 130 conveys information between the smart mobile device 110 and the dispatcher device 120. The mixed network 130 represents a communication path between the smart mobile device 110 and the dispatcher device 120 and can span one or more types of networks, including, for example, a cellular network, a data communications network (e.g., Internet backbone), and a PSTN (public switched telephone network), among others. Persons skilled in the art will understand such portions of the communications path, and they are not illustrated separately or in detail in FIG. 1. As an example, the smart mobile device 110 may be a smartphone that is connected to a cellular network. The cellular network is then physically connected to the Internet backbone. The dispatcher device 120 may be connected to the Internet backbone through data connections such as optical fiber, through media connections such as coaxial cable with a cable modem, through telecommunication connections such as telephone analog voice cables with a DSL modem, and/or through satellite connections such as VSAT ground stations, among other things. The mixed network 130 also includes infrastructure that supports and operates emergency services protocols, such as 911, wireless E-911 and VoIP 911 protocols in the United States, or emergency services protocols in other countries, which persons skilled in the art will recognize. All such network components, protocols, and connections are contemplated to be within the scope of the mixed network 130.

In accordance with aspects of the present disclosure, the disclosed system includes a central server 140 that manages a database of PSAPs (public safety answering points)/dispatchers 142, connection information 144 for the PSAPs/dispatchers, and a database of verified and non-verified users 146. For convenience, the terms PSAP and dispatcher may be used interchangeably herein. The database of PSAPs 142 can be a geographic database that includes geographic coverage information of PSAPs. In various embodiments, the geographic coverage information can be based on geographic coordinates, such as longitude and latitude coordinates or Global Positioning Satellite (GPS) coordinates. In various embodiments, the geographic coverage information can be based on regions, such as a state, county, city, town, and/or municipality, or combinations of one or more regions, among other things. For example, the geographic coverage for a particular PSAP in an urban area may be a portion of a large city, such as the Manhattan borough of New York City. As another example, the geographic coverage of a particular PSAP in a rural or suburban area may include several towns. Persons skilled in the art will recognize various ways of configuring and building the database 142 to implement the geographic coverage information described above.

The database of PSAPs 142 can be accessed to identify the appropriate PSAP to communicate with based on the location of the smart mobile device 110. In various embodiments, the database of PSAPs 142 includes coverage information of all PSAP which are in operation in a region, regardless of whether they are enrolled with the system of the present disclosure. For example, approximately 6,100 PSAPs operate to provide first responder dispatch for the entire United States, and the database of PSAPs 142 can include all such PSAPs even if some of them are not enrolled in the system disclosed herein. If the appropriate PSAP to communicate with is not enrolled with the system of the present disclosure, then a voice call to the PSAP is initiated using existing emergency services protocols (e.g., 911, wireless E-911, and/or VoIP 911 protocols in the United States).

The connection information 144 in the central server is associated with the geographic coverage information in the database of PSAPs, such that the connection information 144 can be used by the central server 140 to connect smart mobile devices 110 with the appropriate PSAP. Communications between the smart mobile devices 110 and dispatcher devices 120 can be routed through the central server 140, and the connection information 144 can include client information of the dispatcher device 120, such as an IP address. Such network connection addresses and server-client architectures will be understood by persons skilled in the art.

The database of verified and non-verified users 146 includes information on users of the disclosed system and their smart mobile devices 110. In various embodiments, because the disclosed system connects users to PSAPs/first responder dispatchers, the identities of the users are verified so that they can be identified by first responders. However, in various embodiments, users may choose to remain non-verified and, for such users, a first responder dispatcher may verify the user’s identity by a voice call that is routed through existing emergency services protocols (e.g., 911 protocols in the United States). Users may download the emergency services software app 112 through an app store, for example. When the software app 112 is first opened, it can require the user to register with the central server 140. For verifying users, the registration may request various information about the user, such as full name, date of birth or age, sex, allergies, medical history and/or preexisting conditions, current medications, telephone number, home address, emergency contact information, and/or insurance information, among other things. Various methods are contemplated for verifying users. For example, in various embodiments, users may upload two or more forms of identification to the central server 140 to verify their name, residential address, and/or picture. Other methods are contemplated for user verification, as well. In various embodiments, users may register with the central server 140 but may remain non-verified. For non-verified users, the central server may collect as much information as the user is willing to provide. The database of verified and non-verified users 146 stores all information provided by the users and indicates whether the users are verified or non-verified. In various embodiments, and as explained in more detail below, the central server 140 may store minimal information for non-verified users. Rather, the user’s smart mobile device 110 locally stores the user information and can provide the information directly to a first responder dispatcher.

The illustration of FIG. 1 is exemplary and variations are contemplated to be within the scope of the present disclosure. For example, the central server 140, the databases 142, 146, and the connection information 144 may be implemented by more than one machine and may be geographically distributed. Such variations are contemplated to be within the scope of the present disclosure.

The paragraphs above described an exemplary system according to the present disclosure for enabling communications between a smart mobile device 110 and a dispatcher device 120. FIGS. 2-7 described below relate to exemplary display screens of an emergency services software app running on a smart mobile device. The display screens of FIGS. 2-7 are displayed when the appropriate PSAP for handling an emergency has enrolled with the system disclosed herein.

In various embodiments, the display screens may be the same for all PSAPs. In various embodiments, the display screens may be customized for different PSAPs, so that the display screens provide information that would be helpful to the particular PSAP. For example, a PSAP covering a large city may benefit from different information than a PSAP covering multiple smaller municipalities. In various embodiments, when the appropriate PSAP for handling an emergency is enrolled in the system of the present disclosure, the central server 140 may communicate to the smart mobile device 110 the display screens or content that is customized for that PSAP, if any. If any display screens or content are communicated by the central server 140 to a smart mobile device 110, the screens and content can be configured to be minimalistic so that they can be communicated quickly to the smart mobile device 110. However, in cases where a communication path between the central server and the smart mobile device is unstable or unreliable, the smart mobile device 110 can utilize default display screens.

Referring now to FIG. 2, there is shown an exemplary display screen of a smart mobile device that is running an emergency services software app according to the present disclosure. The illustrated screen can be displayed when the software app opens and allows a user to indicate whether there is no actual emergency 202 and to identify the person of focus, such as the user 204 or another person 206. The first selection 202 can be selected if the user is reporting an incident that is not an emergency. The second selection 204 can be selected if the user is reporting an emergency affecting herself. The third selection 206 can be selected if the user is reporting an emergency affecting another person. And the fourth selection 208 can be selected to cancel the emergency indication. Additionally, if the user would like to immediately place a voice call to the PSAP, a call button 210 can be selected to initiate an emergency services voice call, such as a 911, wireless E-911, and/or VoIP 911 voice call in the United States. When one of the four selections 202-208 is selected, the display screen can proceed to the display screen of FIG. 3. In the illustration of FIG. 2, the second selection 204 may be selected to indicate the user herself as the person of focus or the third selection 206 may be selected to indicate that another person is the focus of the emergency.

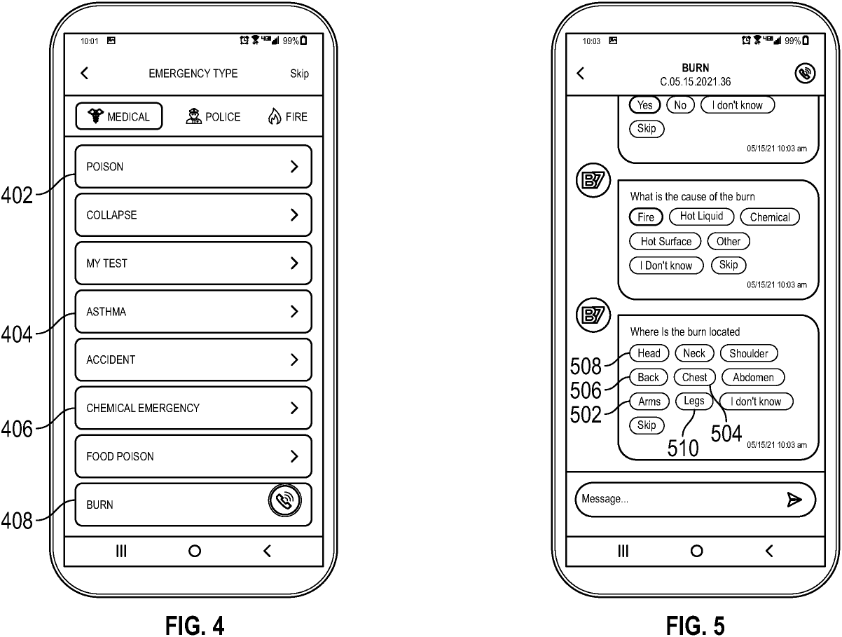

FIG. 3 shows an exemplary display screen for selecting which type of first responder is primarily requested. The user can primarily request a medical first responder 302, a police first responder 304, or a fire department first responder 306. The user can also select a cancel button 308 to cancel the emergency indication, or select a call button 310 to initiate an emergency services voice call, such as a 911, wireless E-911, and/or VoIP 911 voice call in the United States. Additionally, if the user wishes to return to the display screen of FIG. 2, the user can select a back button 312 to do so. When a type of first responder 302-306 is selected, the display screen can proceed to the display screen of FIG. 4. In the illustration of FIG. 3, the first selection 302 is selected to request a medical first responder. Accordingly, the following FIGS. 4-7 relate to a medical emergency. Particular display screens and content relating to fire or police emergencies are not provided or illustrated, but such screens and content can be configured in the same manner to provide information to a dispatcher device regarding particular details for the fire or police emergency.

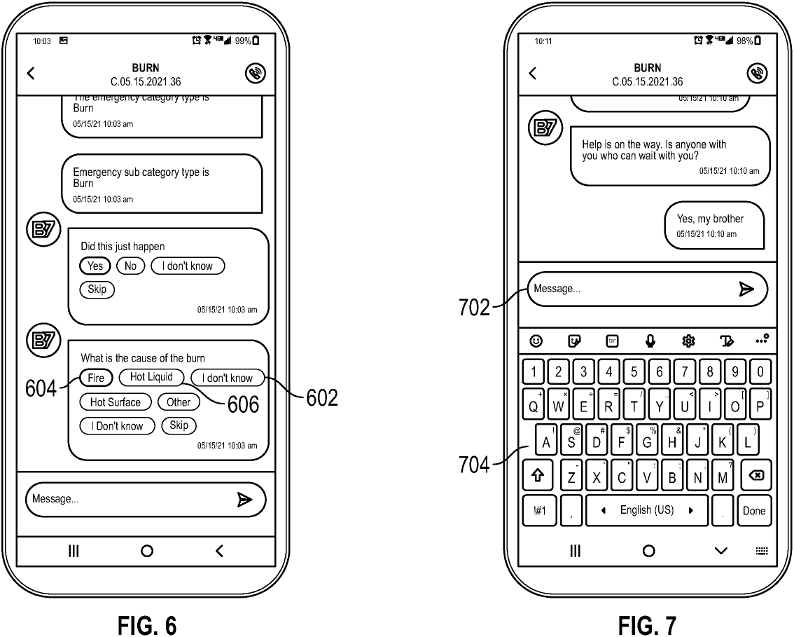

FIG. 4 shows an exemplary display screen for indicating a nature of a medical emergency. The display screen includes a selection for poison 402, a selection for asthma 404, a selection for chemical emergency 406, and a selection for burn 408, among others. The illustrated selections are exemplary and other selections, fewer selections, and/or more selections are contemplated for indicating a nature of a medical emergency. Such other selections are also within the scope of the present disclosure. The display screen of also includes a call button and a back button, and they operate in the same manner described in connection with FIG. 3. The display screen also includes a skip button, which can be used to proceed to the next screen without making a selection. When a selection of FIG. 4 is selected, the display screen can proceed to the display screens of FIG. 5 and FIG. 6. In the illustration of FIG. 4, the selection for burn 408 is selected.

FIG. 5 and FIG. 6 show exemplary display screens for indicating various information about the burn emergency, such as indicating the cause of the burn (FIG. 6) and indicating the location of the burn (FIG. 5). In the illustrations of FIG. 5 and FIG. 6, the selections for indication information about the emergency can be implemented as interactive messages with selection buttons embedded in the messages. Such an embodiment is exemplary, and other implementations are contemplated to be within the scope of the present disclosure.

The display screen of FIG. 5 includes a selection for arms 502, a selection for chest 504, a selection for back 506, a selection for head 508, and a selection for legs 510, among others. The illustrated selections are exemplary and other selections, fewer selections, and/or more selections are contemplated for indicating a location of a bodily injury. Such other selections are also within the scope of the present disclosure. The display screen of also includes a call button and a back button, and they operate in the same manner described in connection with FIG. 3. When a selection of FIG. 5 is selected, the display screen can proceed to the display screen of FIG. 6. In the illustration of FIG. 5, the selection for injury to chest 504 is selected.

FIG. 6 shows an exemplary display screen for indicating the cause of the burn. The selections include a selection for chemical 602, a selection for fire 604, and a selection for hot liquid 606, among others. The illustrated selections are exemplary and other selections, fewer selections, and/or more selections are contemplated for indicating a cause of a burn injury. Such other selections are also within the scope of the present disclosure. The display screen of also includes a call button and a back button, and they operate in the same manner described in connection with FIG. 3. When a selection of FIG. 6 is selected, the display screen can proceed to provide one or more other prompts for indicating information about the emergency, in the same manner as FIG. 5 and FIG. 6. In various embodiments, the particular prompts for gathering information about the emergency may be customized for or by each individual PSAP. In various embodiments, a PSAP may use default prompts provided by the emergency services app.

In various embodiments, and referring also to FIG. 1, the emergency may be communicated to the central server 140 and/or to a dispatcher device 120 once a selection is made in the display screen of FIG. 4. In various embodiments, the emergency may be communicated to the central server 140 and/or to a dispatcher device 120 once particular prompts have been addressed, such as the prompts shown in FIG. 5 and/or FIG. 6, or other prompts. Once the emergency has been communicated to the central server 140 and/or to a dispatcher device 120, the display screen of the emergency services app may show a messaging bar which allows the user to enter and submit messages to the central server 140 and/or to a dispatcher device 120, as shown in FIG. 7.

In FIG. 7, when the messaging bar 702 is selected, a user interface of the smart mobile device is presented to allow the user to enter a message. The user interface may be a keyboard interface 704, as shown in FIG. 7, or may be another user interface, such as a voice input user interface, among other things. The display screens of FIG. 5 and FIG. 6 also include a messaging bar, indicating that the emergency has been communicated to the central server 140 (FIG. 1) and/or to a dispatcher device 120. The messaging screen and user interface of FIG. 7 operate in the same manner as messaging apps and user interfaces known to persons skilled in the art and enable the user and the dispatcher to communicate messages to each other. The messaging feature of FIG. 7 can be hosted by the central server 140 of FIG. 1.

The display screen of the dispatcher device will be described in connection with FIGS. 8-12. For now, it is sufficient to note that location information (114, FIG. 1) for the user’s smart mobile device can be communicated by the central server 140 to the dispatcher device to inform the dispatcher of the location of the emergency. Such location information can be displayed on the display screen of the dispatcher device. Additionally, the identity of verified users (146, FIG. 1) can also be communicated by the central server 140 to the dispatcher device to inform the dispatcher of the identity of the user who initiated the emergency communication. For non-verified users, the user’s smart mobile device can communicate identity information to the dispatcher device.

Accordingly, FIGS. 2-7 relate to exemplary display screens of an emergency services software app running on a smart mobile device and are displayed when the appropriate PSAP for handling an emergency has enrolled with the system disclosed herein. The illustrated display screens are exemplary and variations are contemplated to be within the scope of the present disclosure. For example, a display screen may utilize drop down menus or other selectors, rather than the illustrated button selections. Additionally, the number of display screens and the content of each screen can vary. All such variations are contemplated to be within the scope of the present disclosure.

Particular display screens and content relating to non-emergencies or relating to fire or police emergencies are not provided or illustrated, but such screens and content can be configured in the same manner to provide information to a dispatcher device regarding particular details. Examples of selections that may be displayed in relation to a non-emergency can include, without limitation, the nature of the non-emergency, such as loose dog or minor car accident. Examples of selections that may be displayed in relation to a request for a police first responder can include, without limitation, nature of the emergency (e.g., home invasion, domestic violence), whether any weapons are involved (e.g., firearm), and/or information relating to a perpetrator, among other things. Examples of selections that may be displayed in relation to a request for a fire department first responder can include, without limitation, nature of the emergency (e.g., active fire, gas leak), whether any person is trapped, and/or locations of a trapped person (e.g., basement, second floor). Such details are exemplary, and other display screens and display content are contemplated to be within the scope of the present disclosure.

The following paragraphs will refer to FIGS. 8-12, which show examples of a display screen of a dispatcher device (e.g., 120, FIG. 1). As shown in FIG. 8, a display screen of a dispatcher device can be split into four quadrants. Each quadrant can be configured to connect with a separate emergency services software app of a smart mobile device, such that the display screen of FIG. 8 can simultaneously communicate with four separate emergency services app users. However, the number of display regions on a display screen and the number of simultaneous connections to software app users are exemplary, and other numbers of display regions and simultaneous connections are contemplated to be within the scope of the present disclosure. The software for displaying the display screens and connecting with emergency services app users can be installed on the dispatcher device, and the dispatcher / PSAP can register with the central server (140, FIG. 1). In various embodiments, registration of the dispatcher / PSAP with the central server can involve, for example, allotting resources for handling a particular number of simultaneous connections with emergency services app users.

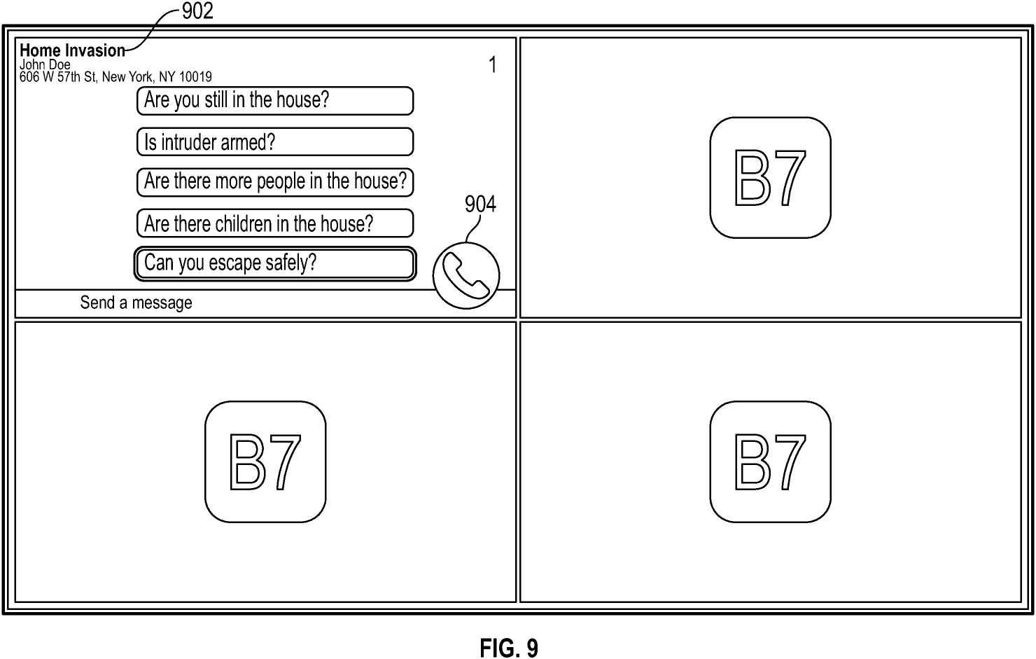

FIG. 9 is an exemplary display screen of a dispatcher device which has connected with one emergency services app user. Based on the information selected by the user in the software app, the user’s emergency is a home invasion and this information 902 is displayed on the display screen of the dispatcher device. The identity and address of the user are also displayed on the display screen. Because the emergency is a home invasion, the address that is displayed is the home address of the user.

In various embodiments, the display screen of FIG. 9 is displayed at the dispatcher device at approximately the time when the user smart mobile device completes the selection screen of FIG. 4 and/or when the user smart mobile device displays the messaging bar of FIGS. 5, 6, and/or 7. At this point of the communication, the user of the smart mobile device has already provided some information about the nature of the emergency using display screens of the emergency services app on the smart mobile device (e.g., display screens of FIGS. 2-4). For any information the user has not provided, the dispatcher can be presented with various messaging options in the display quadrant of FIG. 9. In various embodiments, the messaging options provided to the dispatcher can vary based on the information already provided by the user of the smart mobile device. In the illustration of FIG. 9, the dispatcher selects the message “Can you escape safely?” This message would appear in the messaging screen of the user’s smart mobile device (e.g., FIG. 7). The display quadrant also includes a call button 904, which the dispatcher can select to initiate a voice call with the user. In various embodiments, the user’s contact information can be provided by the central server (140, FIG. 1) based on information for the verified user (146, FIG. 1). In various embodiments, if the user has not been verified by the central system (140, FIG. 1), the user’s contact information can be provided by the smart mobile device to the dispatcher device. In such situations, the display screen can indicate that the user is non-verified (not shown) and can instruct the dispatcher to initiate a voice call with the non-verified user using existing emergency services protocols (e.g., 911 protocols in the United States) to determine or confirm the user’s identity.

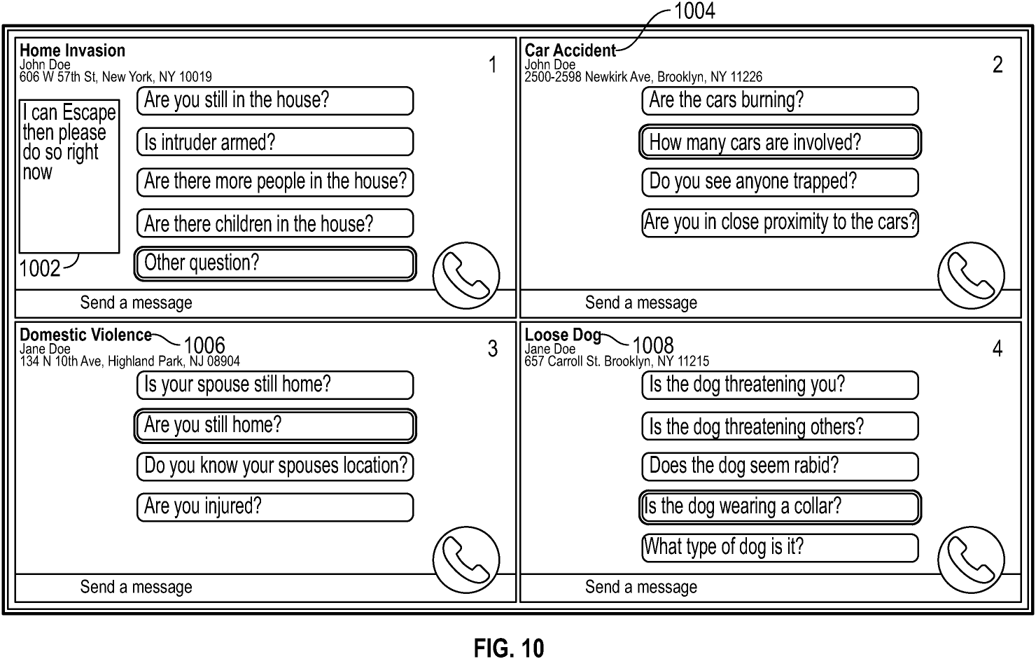

FIG. 10 shows an example of a display screen that follows the display screen of FIG. 9. A message box 1002 shows the user’s response to the message “Can you escape safely?” The user has indicated “I can Escape,” and the dispatcher provides the further message “then please do so right now.” Additionally, the display screen shows in the other display quadrants that the dispatcher device has connected with three other emergency services app users. One user has indicated an automobile accident emergency 1004, one user has indicated a domestic violence emergency 1006, and one user has indicated a loose dog non-emergency 1008. In each display quadrant, the dispatcher can be provided with messaging selections based on information that the users have submitted through the display screens of their emergency services apps. Each display quadrant also includes a call button for connecting a voice call with the smart mobile device user of that quadrant. In various embodiments, when the dispatcher selects one of the call buttons, a voice call is connected with the smart mobile device user of that quadrant, all other sessions for the other quadrants are transferred to one or more available dispatchers, and the messaging applications corresponding to the transferred sessions are closed on the display screen.

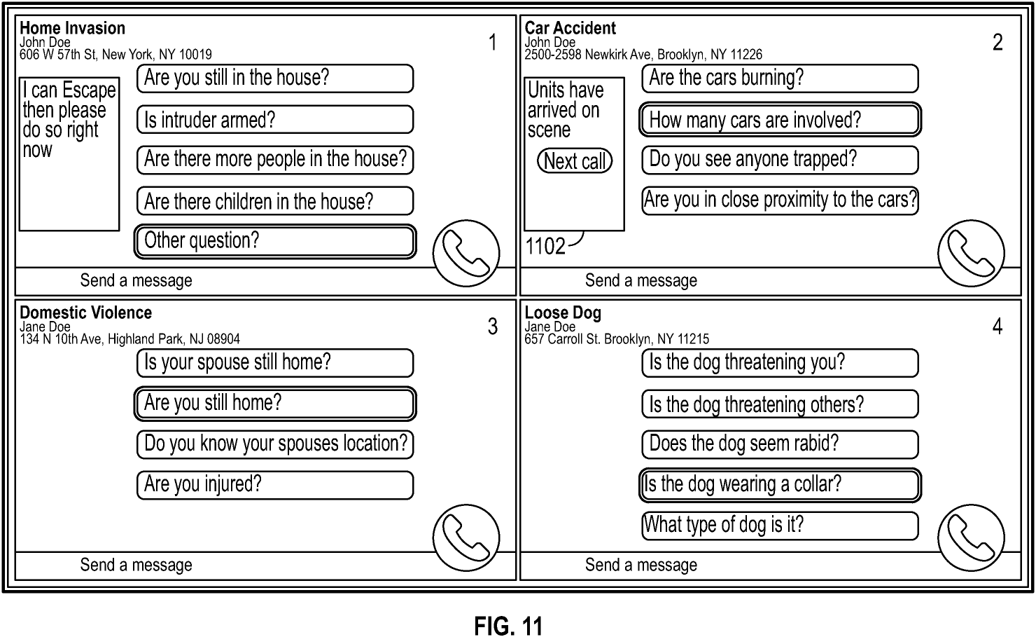

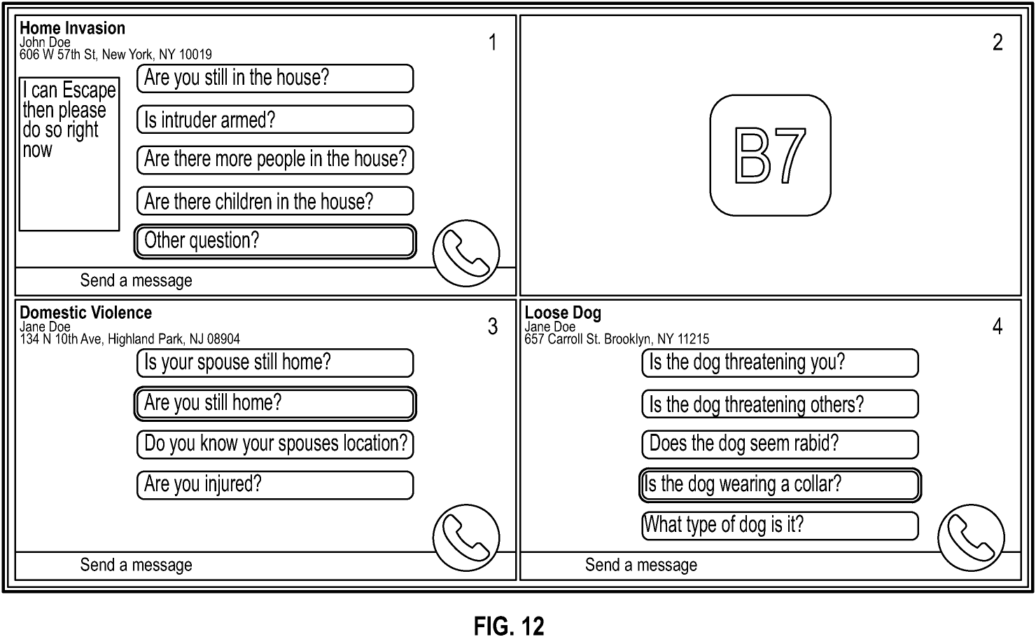

FIG. 11 shows an example of a display screen that follows the display screen of FIG. 10. For the car accident incident in the second display quadrant, a message box 1102 indicates that “units have arrived on scene” and provides the dispatcher with the option to terminate that connection and take a “Next call.” When the dispatcher selects the “Next call” button in message box 1102, the connection terminates, as shown in FIG. 12.

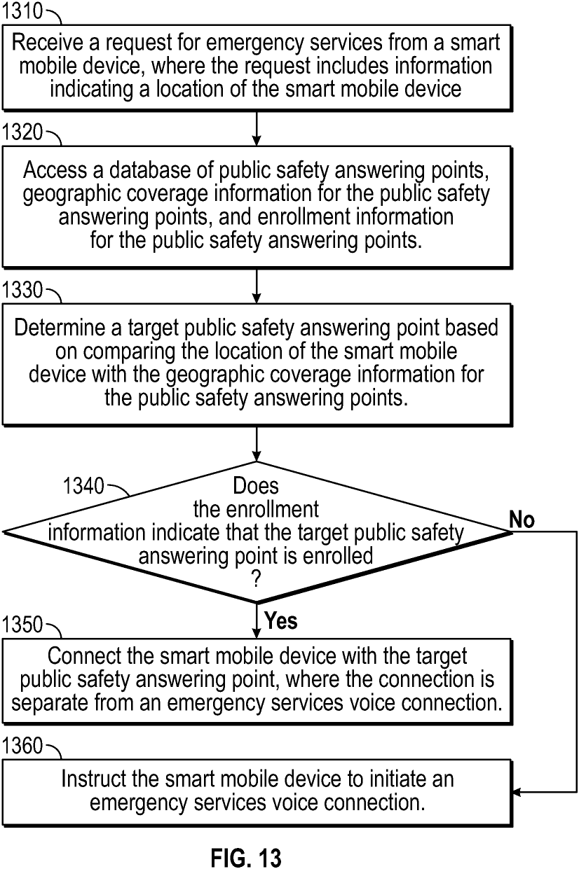

Accordingly, FIGS. 8-12 show examples of a display screen of a dispatcher device for communicating with users of the emergency services app disclosed herein. The layout and content of the illustrations and the various embodiments are exemplary, and variations are contemplated to be within the scope of the present disclosure. FIGS. 13-15 below show examples of various operations described above for the central server, the smart mobile device, and the dispatcher device.

FIG. 13 shows a flow diagram of an exemplary operation of a central server. At block 1310, the operation involves receiving a request for emergency services from a smart mobile device, where the request includes information indicating a location of the smart mobile device. At block 1320, the operation involves accessing a database of public safety answering points, geographic coverage information for the public safety answering points, and enrollment information for the public safety answering points. At block 1330, the operation involves determining a target public safety answering point based on comparing the location of the smart mobile device with the geographic coverage information for the public safety answering points. At block 1340, the operation involves evaluating whether the enrollment information indicates that the target public safety answering point is enrolled. If the target public safety answering point is enrolled, then at block 1350, the operation involves connect the smart mobile device with the target public safety answering point, where the connection is separate from an emergency services voice connection. If the target public safety answering point is not enrolled, then at block 1360, the operation involves instructing the smart mobile device to initiate an emergency services voice connection. The operation of FIG. 13 is exemplary, and variations are contemplated for operations of the central server.

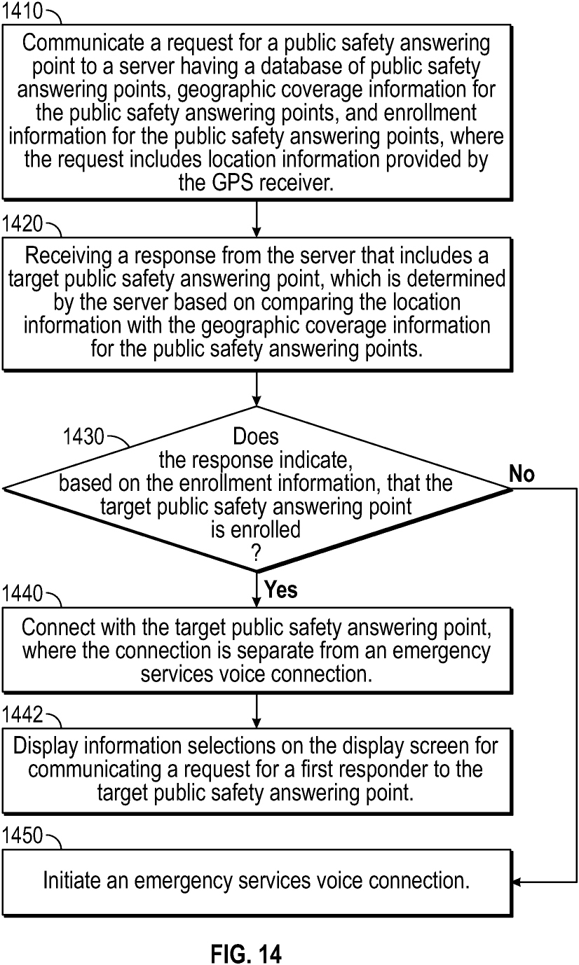

FIG. 14 shows a flow diagram of an exemplary operation of a smart mobile device. At block 1410, the operation involves communicating a request for a public safety answering point to a server having a database of public safety answering points, geographic coverage information for the public safety answering points, and enrollment information for the public safety answering points, where the request includes location information provided by the GPS receiver. At block 1420, the operation involves receiving a response from the server that includes a target public safety answering point, which is determined by the server based on comparing the location information with the geographic coverage information for the public safety answering points. At block 1430, the operation involves evaluating whether the response indicates, based on the enrollment information, that the target public safety answering point is enrolled. If the target public safety answering point is enrolled, then at block 1440, the operation involves connecting with the target public safety answering point, where the connection is separate from an emergency services voice connection. Then, at block 1442, the operation involves displaying information selections on the display screen for communicating a request for a first responder to the target public safety answering point. If the target public safety answering point is not enrolled, then at block 1450, the operation involves initiating an emergency services voice connection. The operation of FIG. 14 is exemplary, and variations are contemplated for operations of the central server.

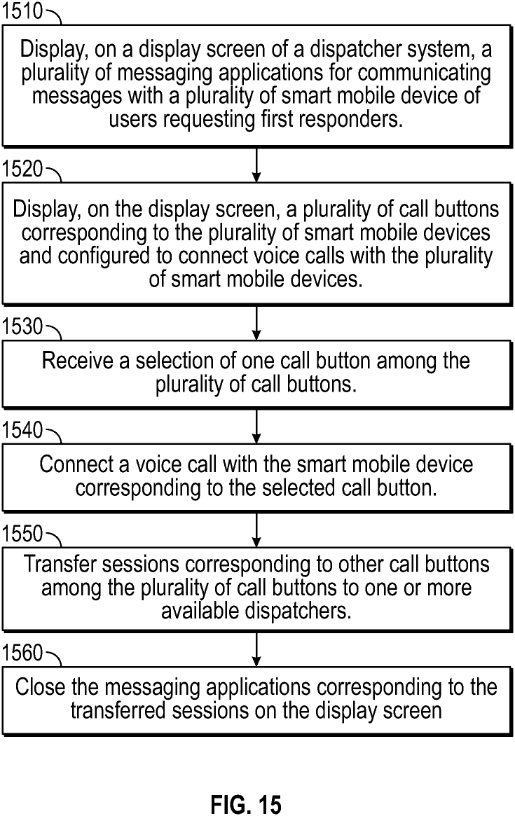

FIG. 15 shows a flow diagram of an exemplary operation of a dispatcher device. At block 1510, the operation involves displaying, on a display screen of a dispatcher device, a plurality of messaging applications for communicating messages with a plurality of smart mobile device of users requesting first responders. At block 1520, the operation involves displaying, on the display screen, a plurality of call buttons corresponding to the plurality of smart mobile devices and configured to connect voice calls with the plurality of smart mobile devices. At block 1530, the operation involves receiving a selection of one call button among the plurality of call buttons. At block 1540, the operation involves connecting a voice call with the smart mobile device corresponding to the selected call button. At block 1550, the operation involves transferring sessions corresponding to other call buttons among the plurality of call buttons to one or more available dispatchers. At block 1560, the operation involves closing the messaging applications corresponding to the transferred sessions on the display screen. The operation of FIG. 15 is exemplary, and variations are contemplated for operations of the central server.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems described herein may also utilize one or more processors to receive various information and transform the received information to generate an output. The processor may include any type of computing device, computational circuit, or any type of processing circuit capable of executing a series of instructions that are stored in a memory. The processor may include multiple processing units and/or multicore central processing units (CPUs) and may include any type of processing device, such as a microprocessor, digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms, or codes may be converted to, or expressed in, a programming language, machine instructions, or computer program, which may be stored on a machine-readable medium. The terms “programming language” and “computer program,” as used herein, each include any language used to specify instructions to a computer or processor, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1-10. (canceled)

11. A mobile device for communicating with a dispatcher device of a first responder dispatcher, the mobile device comprising:
a display screen;
a GPS receiver;
a processor; and
a memory storing instructions which, when executed by the processor, cause the mobile device to:
communicate a request for a public safety answering point to a server having a database of public safety answering points, geographic coverage information for the public safety answering points, and enrollment information for the public safety answering points, the request including location information provided by the GPS receiver;
in case of receiving a response from the server that a target public safety answering point, determined by the server based on comparing the location information with the geographic coverage information for the public safety answering points, is enrolled based on the enrollment information:
connect with the target public safety answering point, wherein the connection is separate from an emergency services voice connection, and
display information selections on the display screen for communicating a request for a first responder to the target public safety answering point; and
in case of receiving a response from the server that the target public safety answering point is not enrolled, initiate an emergency services voice connection.

12. The mobile device according to claim 11, wherein the information selections are customized to the target public safety answering point and are received from the server.

13. The mobile device according to claim 11, wherein the information selections are default information selections.

14. The mobile device according to claim 11, wherein, in the case the target public safety answering point is enrolled, the instructions, when executed by the processor, further cause the mobile device to:
display, on the display screen, a call button configured to connect an emergency services voice call to the target public safety answering point.

15. A method in a mobile device for communicating with a dispatcher device of a first responder dispatcher, the mobile device including a display screen and a GPS receiver, the method comprising:
communicating a request for a public safety answering point to a server having a database of public safety answering points, geographic coverage information for the public safety answering points, and enrollment information for the public safety answering points, the request including location information provided by the GPS receiver;
in case of receiving a response from the server that a target public safety answering point, determined by the server based on comparing the location information with the geographic coverage information for the public safety answering points, is enrolled based on the enrollment information:
connecting with the target public safety answering point, wherein the connection is separate from an emergency services voice connection, and
displaying information selections on the display screen for communicating a request for a first responder to the target public safety answering point; and
in case of receiving a response from the server that the target public safety answering point is not enrolled, initiating an emergency services voice connection.

16. The method according to claim 15, wherein the information selections are customized to the target public safety answering point and are received from the server.

17. The method according to claim 15, wherein the information selections are default information selections.

18. The method according to claim 15, further comprising, in the case the target public safety answering point is enrolled, displaying, on the display screen, a call button configured to connect an emergency services voice call to the target public safety answering point.

19. A machine-readable medium storing instructions which implement an operation in a mobile device for communicating with a dispatcher device of a first responder dispatcher, the mobile device including a display screen and a GPS receiver, the instructions, when executed by one or more processors, cause performance of the operation comprising:
communicating a request for a public safety answering point to a server having a database of public safety answering points, geographic coverage information for the public safety answering points, and enrollment information for the public safety answering points, the request including location information provided by the GPS receiver;
in case of receiving a response from the server that a target public safety answering point, determined by the server based on comparing the location information with the geographic coverage information for the public safety answering points, is enrolled based on the enrollment information:
connecting with the target public safety answering point, wherein the connection is separate from an emergency services voice connection, and
displaying information selections on the display screen for communicating a request for a first responder to the target public safety answering point; and
in case of receiving a response from the server that the target public safety answering point is not enrolled, initiating an emergency services voice connection.
